(19) United States
(12) Patent Application Publication
(10) Pub. No.: US 2011/0230122 A1
(43) Pub. Date: Sep. 22, 2011

(54) NANOSCALE CUBIC BORON NITRIDE

(75) Inventors: Yann Le Godec, Paris (FR); Vladimir Solozhenko, Clichy (FR); Oleksandr Kurakevych, Viry-Chatillon (FR); Natalia Doubrovinckaia, Creussen (DE); Leonid Doubrovinski, Creussen (DE)

(73) Assignees: CENTRE NATIONAL DE LA RECHERCHE SCIENTIFIQUE, Paris (FR); Universite Pierre Et Marie Curie (Paris 6), Paris (FR)

(21) Appl. No.: 13/003,651

(22) PCT Filed: Jul. 9, 2009
(86) PCT No.: PCT/FR09/00852

§ 371 Date: Jun. 15, 2011

(30) Foreign Application Priority Data
Jul. 11, 2008 (FR) 08 03976

(51) Int. Cl. B24B 1/00; C01B 21/064; C04B 35/645; B32B 5/16; B82Y 30/00; B82Y 40/00

(52) U.S. Cl. 451/28; 423/290; 264/668; 428/402; 977/773; 977/900

(57) ABSTRACT

The invention relates to a method of manufacturing nanoscale cubic boron nitride and to the nanoscale cubic boron nitride thus obtained. The method according to the invention of manufacturing nanoscale boron nitride of cubic structure is characterized in that it comprises the following steps: a) compression of a pyrolytic boron nitride powder having a structure of the monomodal turbostratic graphite type at a pressure of between 19 and 21 GPa and at room temperature; and b) heating of the powder under a pressure of between 19 and 21 GPa and at a temperature of between 1447° C. (1720 K) and 1547° C. (1820 K) for less than 2 minutes. The invention is applicable in particular in the field of abrasives.

The invention relates to a process for manufacturing nano cubic boron nitride and to the nano cubic boron nitride obtained by this process and to the use thereof.

Cubic boron nitride (cBN) is the superabrasive of choice for machining hard steels because its chemical stability and thermal stability are higher than those of diamond.

This cubic boron nitride is obtained with a particle size of the order of 1 cm³, the particles consisting of polycrystalline boron nitride, i.e. composed of crystals (grains) bonded together by grain boundaries, the grains having a size of about 10 microns.

However, such cubic boron nitride has a Vickers hard-ness Hᵥ of 62 GPa for the (111) face of the single crystal. This hardness is half that of diamond, which has a Vickers hardness H_{V} of 115 GPa for the (111) face of the single crystal.

Thus, such cubic boron nitride cannot completely replace diamond.

Since the first synthesis of cBN, a large number of ultra-hard diamond-like phases have been synthesized, both in the form of thin films and in the form of bulk materials. Nanocrystalline phases and microcrystalline phases of boron carbonitride, c-BC₂N and c-BCN, having Knoop hardnesses H_{K} of 52 GPa and 56 GPa respectively, have been claimed as the hardest materials after diamond, which has a Knoop hardness H_{K} of 63 GPa for the (111) face of the single crystal.

However, all these phases are thermodynamically meta-stable.

Nano cubic boron nitride, i.e. having crystals with a size of around 10 to 30 nm, has been obtained, but in the form of films and not in the form of free (bulk) particles and, in addition, always as a mixture with other boron nitride phases.

Thus, Saitoh et al. have described the deposition of a film of nano boron nitride, containing both cubic and turbostratic phases, on a silicon substrate in “Nucleation of boron nitride on cubic boron nitride microcystallites using chemical vapor deposition”, Applied Physics Letters, 64 (1994) March 28, No. 13, Woodbury, N.Y., US.

The production of nano cubic boron nitride in thin-film form has also been described by Thevenin et al., but here again this is nano cubic boron nitride deposited in the form of films that contain only a cubic boron nitride fraction and not free particles of nano cubic boron nitride alone.

Now, nano cubic boron nitride has theoretically a higher hardness than conventional polycrystalline diamond.

As already mentioned, there is a crucial need in industry for superhard materials that are hard, tough and at the same time thermally stable, in particular for cutting and drilling.

In this context, the invention provides an ultra-hard material, the hardness of which exceeds even that of polycrystalline diamond and approaches that of single-crystal diamond, said material exhibiting exceptional fracture toughness and exceptional wear resistance. In addition, the thermo-chemical stability, in particular the thermo-oxidative stability, of the material of the invention is superior to that of diamond.

To achieve this, the invention provides a process for manufacturing nano cubic boron nitride, characterized in that it comprises the following steps:

a) compression of a powder of pyrolytic boron nitride having a monomodal turbostratic graphitic structure at a pressure of between 19 and 21 GPa and at room temperature; and

b) heating of the starting powder under a pressure of between 19 and 21 GPa at a temperature of between 1447° C. (1720 K) and 1547° C. (1820 K) for less than 2 minutes.

Preferably, the pressure in step a) is 20 GPa and the temperature in step b) is 1497° C.

In a first method of implementing the process of the invention, steps a) and b) are carried out in a multi-anvil press.

The size of the particles obtained by this process is 3 mm³, with a grain size between 10 and 30 nm.

The invention also provides a nano cubic boron nitride that can be obtained by the process according to the invention, characterized in that it consists solely of nano polycrystalline cubic boron nitride particles, each particle having a diameter of between 1.8 mm and 2.2 mm, i.e. a mean diameter of 2 mm, over a height of 1 mm (values measured using a sliding caliper), and consisting of grains (crystals) of nano cubic boron nitride having a diameter of between 10 nm and 30 nm, i.e. a mean diameter of 20 nm (values measured using transmission electron microscopy), the grains being bonded together by covalent bonds.

Finally, the invention provides for the use of the nano cubic boron nitride according to the invention or that obtained by the process according to the invention, as superabrasive.

The invention will be better understood and other advantages and features thereof will become more clearly apparent on reading the following explanatory description with reference to the figures, in which:

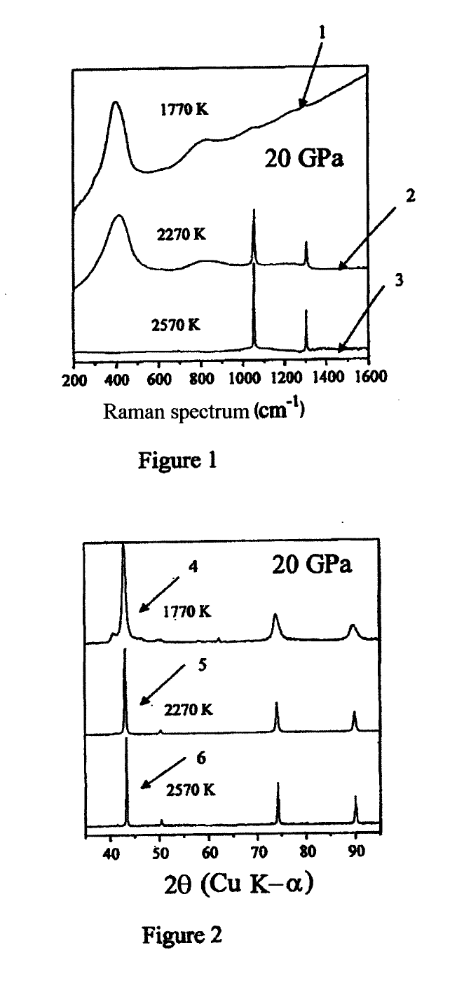

FIG. 1 shows the Raman spectrum of the nano cubic boron nitride according to the invention in comparison with the Raman spectra of nano boron nitrides not forming part of the invention;

FIG. 2 shows the X-ray diffraction pattern of the nano cubic boron nitride of the invention in comparison with the X-ray diffraction patterns of nano boron nitrides not forming part of the invention;

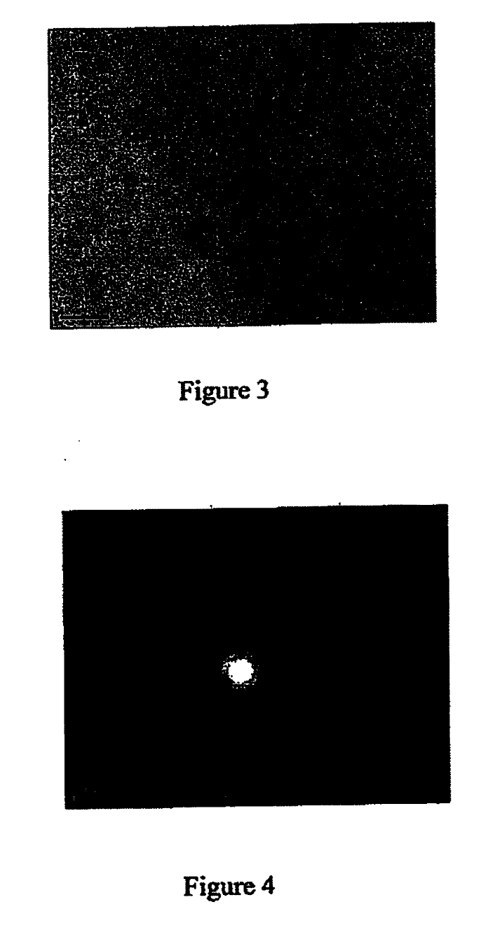

FIG. 3 shows the ATEM (analytical transmission electron microscopy) image of the particles in the specimen of nano cubic boron nitride according to the invention;

FIG. 4 shows the SAED (selected-area electron diffraction) pattern of the nano cubic boron nitride of the invention;

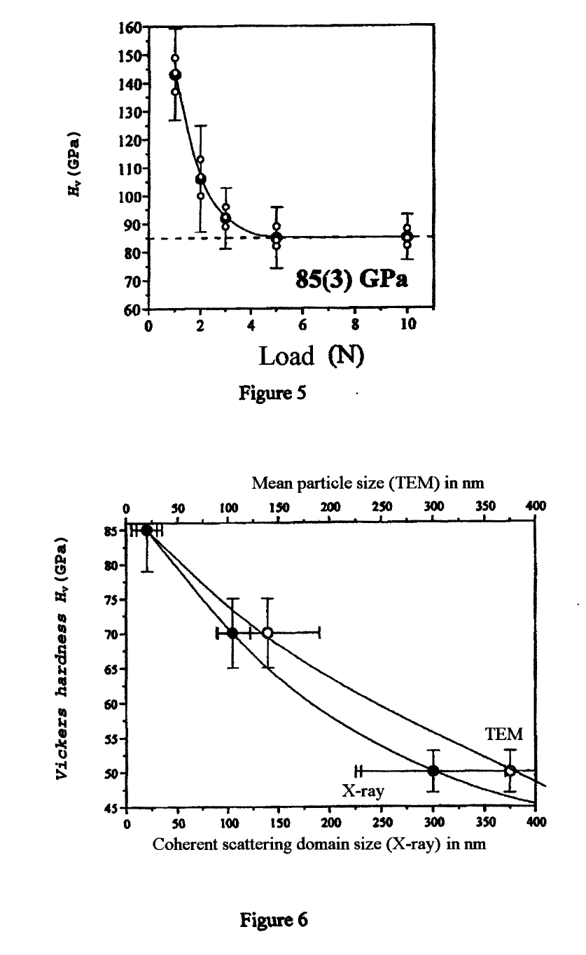

FIG. 5 shows the variation in Vickers hardness of the nano cubic boron nitride according to the invention as a function of the force applied by the indentor; and

FIG. 6 shows the variation in the Vickers hardness as a function of the size of the crystallites (coherent diffraction domains) in nanometers of the nano cubic boron nitride of the invention and of polycrystalline cubic boron nitride, measured by transmission electron microscopy and by X-ray diffraction.

The meanings of the terms used here are the following:
“nano boron nitride”: a boron nitride having an individual crystal size between 1 nm and 50 nm inclusive;
“nano polycrystalline boron nitride”: a nano boron nitride consisting only of particles which themselves consist of nano boron nitride grains (crystals) bonded together by grain boundaries; and
“room temperature”: a temperature between 15 and 30° C. inclusive.

The nano cubic boron nitride of the invention is a polycrystalline nano cubic boron nitride, i.e. it consists solely of free particles having a diameter between 1.8 mm and 2.2 mm, i.e. a mean diameter of 2 mm, and a height of 1 mm, these particles themselves consisting of grains (crystals) of nano cubic boron nitride bonded together by grain boundaries.

The nano polycrystalline cubic boron nitride of the invention was synthesized from pyrolytic boron nitride, denoted hereafter by pBN, having an ideal turbostratic structure (i.e. a set of interlayer spacing and random mutual orientation of the layers) so as to prevent the formation of other dense boron nitride polymorphs at moderate temperatures.

In fact the first attempts by the inventors to synthesize nano cubic boron nitride from commercial pyrolytic boron nitride, at 18 GPa and 1900 K, resulted in a super-hard aggregated boron nitride nanocomposite, but this material contained both the nano cubic boron nitride phase and the wurtzite boron nitride (wBN) phase. Although having an extremely high hardness, this material in its entirety had inherited the low thermal stability of wBN, therefore being of no industrial interest. At 18 GPa and 1627° C. (1900 K), the nano-wBN phase forms in the ordered domains of the hexagonal boron nitride (hBN) type, according to a martensitic mechanism, whereas nano cubic boron nitride forms in the completely disordered (turbostratic) domains according to a more complicated structural mechanism. The formation of wBN is inevitable when standard commercial specimens of pyrolytic boron nitride are used, these being characterized by a nonzero degree of three-dimensional order (p_{3˜0.2} to 0.4).

The parameter p₃ is the ratio of the number of mutually oriented layers (hBN domain) to the total number of layers.

But, various trials were carried out at temperatures of 1497° C. (1770 K), 1997° C. (2270 K) and 2297° C. (2500 K), under a pressure of 20 GPa, in order to synthesize cubic boron nitride by employing monomodal pyrolytic boron nitride with an ideal turbostratic structure.

No wBN formation was observed in this temperature interval.

The X-ray diffraction spectra of the cBN specimens thus synthesized are shown in FIG. 2.

In FIG. 2, the X-ray diffraction spectrum noted 4 is the X-ray diffraction spectrum of the specimen of nano cubic boron nitride synthesized at 1497° C. (1770 K), the X-ray diffraction spectrum noted 5 is the diffraction spectrum of the specimen synthesized at 1997° C. (2270 K) and the spectrum noted 6 corresponds to the X-ray diffraction spectrum of the specimen synthesized at 2297° C. (2570 K).

It may be seen that, in the case of the specimen synthesized at 2297° C. (2570 K), very narrow lines indicate the formation of the cBN polycrystalline phase (coherent scattering domain size of 350 nanometers).

By lowering the temperature to 1997° C. (2270 K), the diffraction lines of the synthesized specimen broaden considerably, this corresponding to changes both in the size of the blocks of the two coherent scattering domains (105 nm) and to structural imperfections.

The specimen obtained at a temperature of 1497° C. (1770 K) has a powder diffraction pattern with the broadest lines observed. This pattern is characteristic of the specimen of nano cubic boron nitride of the invention.

The size of the coherent scattering domains is 20 nm, this being in good agreement with the 10 to 30 nm size of the grains (individual crystals) observed by TEM (transmission electron microscopy), as shown in FIG. 3.

These grains are bonded together by grain boundaries formed solely by the creation of covalent bonds between each grain.

Indeed, with the process of the invention which is carried out at high pressure, there is no need to add a binder to form nano boron nitride particles.

This is an advantage, firstly because the grain boundaries are then devoid of impurities and secondly because these binders are very thin, with a width of the order of the interatomic distance, thereby making it possible to obtain polycrystalline nano boron nitride particles of exceptional mechanical resistance (hardness, etc.).

In contrast with the processes of the prior art, the process of the invention makes it possible to obtain only polycrystalline nano cubic boron nitride particles, to the exclusion of any other crystalline phase and of any other material: neither a film nor a mixture of crystalline phases is obtained.

Thus, the nano cubic boron nitride according to the invention was synthesized at 1497° C. (1770 K) and under 20 GPa.

The nano cubic boron nitride of the invention was also synthesized within the 1497° C. (1770 K)±50° C. temperature range, i.e. between 1447° C. (1720 K) and 1547° C. (1820 K) inclusive, under a pressure of between 19 and 21 GPa.

Thus, the nano cubic boron nitride of the invention was synthesized at a temperature between 1447° C. (1720 K) and 1547° C. (1820 K) and under 20 GPa.

At lower temperatures, untransformed pyrolytic boron nitride becomes visible in the powder diffraction patterns.

The Raman spectra of the specimens synthesized at these temperatures are shown in FIG. 1.

The Raman spectrum of the specimen of nano cubic boron nitride according to the invention is noted 1 in FIG. 1 and the Raman spectrum of the specimen synthesized at 1997° C. (2270 K) is noted 2, while the Raman spectrum of the specimen synthesized at 2297° C. (2570 K) is noted 3.

The spectra of the two specimens obtained at 1997° C. (2270 K) and 2297° C. (2570 K) are dominated by two narrow Raman peaks at about 1057 and 1309 cm⁻¹. These peaks may be assigned to scattering via their E_{2g} transverse optical (TO) and longitudinal optical (LO) phonon modes of the cubic boron nitride. As regards the spectrum of nano cubic boron nitride according to the invention, this differs significantly from the others: it is dominated by broad bands centered at about 400, about 800, about 1050 and about 1250 and 1300 cm⁻¹ which are associated with scattering by the many grain boundaries in the very thin nanocrystalline material, as has already been observed in the case of nanocrystalline diamond. Such a Raman spectrum, which has never been reported hitherto for a boron nitride phase, is considered as characteristic of the novelly synthesized material.

The transmission electron microscopy (TEM) results show that the grain size (each grain being a nano cubic boron nitride crystal) is 10 to 30 nm for the nano boron nitride according to the invention synthesized at 1497° C. (1770 K), 125 to 175 nm for the specimen synthesized at 1997° C. (2270 K) and 250 to 450 nm for the specimen synthesized at 2297° C. (2570 K) and that the diameter of the particles is around 2 mm, depending on the press used.

More precisely, with a 5000-tons Zwick-Voggenreiter press, the particles have a mean diameter of 2 mm over a height of 1 mm, and with a miniature Paris-Edinburgh multi-anvil press, the particle size is slightly lower, with a mean diameter of 1.2 mm over a height of 1 mm.

The diameters, mean diameters and heights of the particles were measured using a sliding caliper.

The diameters and mean diameters of the grains were measured by transmission electron microscopy (TEM).

These values are in good agreement with the size of the coherent scattering domains derived from the X-ray diffraction data. The observed SAED rings correspond to the nano cubic boron nitride phase for all the specimens.

FIG. 3 shows the bright-field TEM image and FIG. 4 shows the SAED pattern of the specimen synthesized under 20 GPa and at 1497° C. (1770 K), i.e. the nano boron nitride according to the invention.

The Vickers hardness of this specimen according to the invention was measured as a function of the applied load.

FIG. 5 shows the results obtained.

As recommended for hard brittle materials, the hardness of the nano cubic boron nitride according to the invention is recorded in the asymptotic hardness region. The increase by a factor of 2 of the hardness of the nano cubic boron nitride of the invention, with a Vickers hardness H_{V} of 85 GPa, over the Vickers hardness of the conventional polycrystalline cubic boron nitride, ranging from 40 to 50 GPa, as shown in FIG. 5, is the result of a nanosize effect that restricts the propagation of dislocations through the material.

FIG. 6, which shows the Vickers hardness curve of the nano cubic boron nitride according to the invention as a function of the crystallite size, clearly indicates that the reduction in grain size is accompanied by an increase in hardness from about 40 GPa in the case of the polycrystalline material with a grain size greater than 500 nm to 85 GPa in the case of a crystallite size of about 20 nm. This dependency satisfies the Hall-Petch equation below:

$$H = {H}_{0} + \frac{K}{\sqrt{〈 L 〉}}$$

in which H₀=44 GPa and K=214 GPa·nm^{1/2}.

The fracture toughness K_{1c}, value of 10.5 MPa·m^{1/2} of the nano cubic boron nitride of the invention is appreciably higher than the corresponding value of all the known phases of the B-C-N system (5.3 MPa·m^{1/2} for single-crystal and polycrystalline diamond phases, 2.8 and 6.8 MPa·m^{1/2} for single-crystal and polycrystalline cBN respectively and 4.5 MPa·m^{1/2} for polycrystalline c-BC₂N).

To compare the wear resistance, denoted W_{H}, of the nano cubic boron nitride of the invention with that of both cBN and diamond, the equation linking W_{H} with Young's modulus (˜770 GPa, H_{K} (˜60-65 GPa) and K_{1c} (10.5 MPa·m^{1/2}) was used (i.e. W_{H}=K_{1c}^{0.5}H_{K}^{1.43}/E^{0.8}, where E is Young's modulus).

The W_{H} value for the nano cubic boron nitride of the invention is 5.9, this being extremely high in comparison with that of single-crystal natural diamond (˜2 to 5), polycrystalline diamond (˜3 to 4) and single-crystal cBN (˜3).

The dynamic thermogravimetric/differential thermogravi-metric (TG/DTG) measurements show the high thermo-oxidative stability of the nano cubic boron nitride of the invention: the initial oxidation temperature in air is 1187° C. (1460 K), this being slightly lower than that of polycrystalline boron nitride for which oxidation starts at 1247° C. (1520 K), but appreciably higher than the oxidative stability of polycrystalline diamond and of nanodiamond with the same mean grain size of 10 to 15 nm (oxidative stability only up to 677° C. (950 K), 825° C. (1100 K) in the case of polycrystalline diamond and 597° C. (870 K) in the case of nanodiamond).

Thus, the bulk nano cubic boron nitride material of the invention was synthesized. It has extremely high wear resistance, fracture toughness and hardness values in addition to high thermo-chemical stability. This combination of properties offers unique opportunities for industrial applications of this material. In particular, the nano cubic boron nitride of the invention may be used as superabrasive, whether for drilling or cutting hard steels.

In order for the invention to be better understood, a purely illustrative and nonlimiting example of its implementation is given below.

### EXAMPLE 1

### Synthesis of Nano Cubic Boron Nitride of the invention

Bulk pyrolytic boron nitride (pBN) obtained by the technique of chemical vapor deposition was used as starting material.

The powder X-ray diffraction spectrum of the pBN used shows that the degree of order p₃ of the three-dimensional structure was equal to 0, meaning that there was complete absence of /hkl/ reflections, with a highly asymmetric /100/line. Thus, the structure is purely turbostratic. The p₃ value represents the ratio of the number of mutually oriented layers (hBN domains) to the total number of layers and can be calculated using either the width of the lines or the shape of the profile of the (112) line (when it exists).

The high-pressure syntheses were carried out using a two-stage large-volume multi-anvil system of the 6-8 type with a 5000-tons Zwick-Voggenreiter press. The assembly for the specimen consisted of an MgO octa-hedron containing 5% by weight of Cr₂O₃ with a side length of 18 mm containing an LaCrO₃ heater. The octahedron was compressed using eight 54-mm tungsten carbide anvils with a truncation side length of 10 mm and pyrophyllite seals. The temperature of the specimen was controlled by a W3% Re—W25% Re thermocouple placed axially with respect to the heater and with one junction close to the specimen without correcting for the pressure effect on the thermocouple. The pressure of the specimen at high temperature as a function of the hydraulic oil pressure was calibrated using the P-T diagrams for MgSiO₃ and Mg₂SiO₄. The uncertainty in the pressure and temperature were estimated to be 1 GPa and 50° C. (50 K) respectively. The specimens were gradually compressed up to the desired pressure at room temperature, after which the temperature was increased incrementally with a heating rate of 100° C./min (100 K/min) up to the desired value. The heating time was at most 2 minutes in the various trials. The specimens were quenched by cutting off the electric power and then slowly decompressed. They were taken out of the press in the form of translucent cylinders of a shiny black material having a diameter of between 1.8 mm and 2.2 mm.

The recovered specimens were analyzed by powder X-ray diffraction. An INEL powder X-ray diffractometer, using the Cu Kα line and in a Bragg-Brentano geometry, was used. The goniometer was aligned using high-purity silicon (a=5.431066 Å) and the LaB₆ standard specimen (a=4.15695 Å). The unit cell parameters, the coherent diffraction domain sizes and the stresses were derived by analyzing the LeBail profile obtained using the GSAS (General Structure Analysis System) program.

The Raman spectra were collected using a Dilor XY Raman spectrometer operating with an He—Ne laser at 514 nm. The scattered light was collected in backscattering geometry using a CCD (charge-coupled device) detector cooled by liquid nitrogen. The power of the incident laser ranged from 50 to 250 mW. The spectrometer was calibrated using the Γ₂₅ phonon of diamond-structured Si (Fd-3 m). Under the ambient conditions, a resolution of 2.4 cm in the position of the Raman peaks was esti-mated.

The ATEM studies on the specimens were carried out using a JEM 2010HR transmission electron microscope (from JEOL) operating at 200 kV. The specimens in powder form were dispersed in a drop of ethanol and then placed on copper grids coated with a film of carbon. The microstructure of the specimens was characterized by bright-field HRTEM (high-resolution transmission electron microscopy) and by SAED (selected-area electron diffraction). To obtain the interplanar spacings of the specimen, the patterns of the SAED rings were quantitatively evaluated using the “Process Diffraction” program.

These studies showed that the cylinders obtained consisted solely of nano cubic boron nitride.

The Vickers hardness measurements were carried out on the specimen using a microhardness tester (Duramin-20 from Struers) under a load of 1 to 20 N. A hard steel (421HV0.1, MPANRW 725001.1105) standard and a cubic boron nitride single crystal were used as references. At least four indentations were made for each point in order to provide good statistics. As recommended for hard brittle materials, the hardness is recorded in the asymptotic hardness region. The radial cracks observed at loads of 10 and 20 N made it possible to calculate the reliable load-independent value of the fracture toughness using the method described by V. L. Solozhenko et al. in Diamond and Related Material 10, 2228 (2001) which had been used previously for other superhard materials.

The dynamic TG/DTG measurements in air were carried out using a Netzsch STA 449 C instrument operating with a heating rate of 18° C./min over the temperature range from 27° C. (300 K) to 1367° C. (1640 K).

The results obtained of all of these analyses are those reported in the above description.

1. A process for manufacturing nano cubic boron nitride, the process comprising:
a) compressing a powder of pyrolytic boron nitride having a monomodal turbostratic graphitic structure at a pressure of between 19 and 21 GPa and at room temperature; and
b) heating the powder under a pressure of between 19 and 21 GPa at a temperature of between 1447° C. (1720 K) and 1547° C. (1820 K) for less than 2 minutes.

2. The process of claim 1, wherein the pressure in the compressing a) is 20 GPa and the temperature in the heating b) is 1497° C.

3. The process of claim 1, wherein the compressing a) and the heating b) are carried out in a multi-anvil press.

4. A nano cubic boron nitride, obtained by the process of claim 1, consisting of:
nano polycrystalline cubic boron nitride particles, having a diameter of between 1.8 mm and 2.2 mm, and a mean diameter of 2 mm,
wherein grains of nano cubic boron nitride have a diameter of between 10 nm and 30 nm, and a mean diameter of 20 nm, and
the grains are bonded together by covalent bonds.

5. A superabrasive, comprising the nano cubic boron nitride of claim 4.

6. A superabrasive, obtained by the process of claim 1.

7. A process for abrading a surface, the process comprising contacting the surface with the nano cubic boron nitride of claim 1.

8. A process for abrading a surface, the process comprising contacting the surface with the nano cubic boron nitride of claim 4.
